(19) United States
(12) Patent Application Publication
(10) Pub. No.: US 2008/0207866 A1
(43) Pub. Date: Aug. 28, 2008

(54) Radiation-Curable Binder

(75) Inventors: Marta Martin-Portugues, Ludwigshafen (DE); Jorg Schneider, Wezembeek-Oppern (BE); Gunter Scherr, Ludwigshafen (DE); Martin Reif, Romerberg (DE); Wolfgang Paulus, Ober-Olm (DE); Harald Larbig, Rosenheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaf, Ludwigshafen (DE)

(21) Appl. No.: 11/995,002

(22) PCT Filed: Jul. 21, 2006
(86) PCT No.: PCT/EP06/64550

§ 371 Date: Jan. 8, 2008

(30) Foreign Application Priority Data
Jul. 28, 2005 (DE) 10 2005 035 980.9

(51) Int. Cl. C08G 16/02

(52) U.S. Cl. 528/246

(57) ABSTRACT

The present invention relates to a radiation-curable binder obtainable by reacting A) amine-formaldehyde condensates with a molar ratio of formaldehyde to amino groups of 1:6 to 2:1 with B) a mixture of butanediol monoacrylate and 2-hydroxethyl methacrylate in a ratio of 0.1:100 to 100:0.1, using 0.1 to 1.5 hydroxy equivalents of component B) per methylol equivalent of component A). The present invention further relates to a curable coating composition which comprises the binder of the invention and to a coated article produced using the coating composition.

The present invention relates to a radiation-curable binder obtainable by reacting A) amine-formaldehyde condensates with a molar ratio of formaldehyde to amino groups of 1:6 to 2:1 with B) a mixture of butanediol monoacrylate and 2-hydroxethyl methacrylate in a ratio of 0.1:100 to 100:0.1, using 0.1 to 1.5 hydroxy equivalents of component B) per methylol equivalent of component A). The present invention further relates to curable coating compositions which comprise the binder of the invention and to coated articles produced using the coating compositions.

It is general knowledge that binders which carry monoolefinically unsaturated groups, such as acrylate groups, can be cured by means of high-energy radiation.

Binders of this kind can be used in the preparation of coating compositions.

In this case the radiation cure is frequently utilized only for rapid initial curing, in order to prevent the coated articles sticking to one another, which is significant particularly in the mass production of coated articles.

DE-A 17 45 540 discloses a process for preparing self-crosslinking copolymers by polymerizing monomeric reaction products of polymethylolmelamine and compounds of acrylic acid or maleic acid type with other ethylenically unsaturated monomers. Acrylic acid types disclosed are acrylic acid, ethyl acrylate, butyl acrylate, monoethylene glycol acrylate, methacrylic acid, monoethylene glycol methacrylate, and monopropylene glycol methacrylate. The reaction products described are used for example in the coatings industry for producing coatings.

DE-A 25 50 740 discloses radiation-curable coating compositions comprising, as binders, amino resins which carry (meth)acrylic groups. These coating compositions, however, comprise relatively large amounts of free (meth)acrylate monomers, which in the course of processing leads to problems in relation on the one hand to the environmental burden and on the other hand to the performance properties. Coating compositions comprising more than 1% by weight of residual monomers are subject to mandatory labeling.

EP-B 464 466 describes reaction products from the reaction of A) amine-formaldehyde condensates with B) esters, containing at least one free hydroxyl group, of acrylic or methacrylic acid with polyalcohols comprising two to four alcoholic hydroxyl groups, in the presence of acids having a pK value <3.0 as catalyst, with distillative removal of volatile reaction products under reduced pressure, using 0.1 to 0.3 hydroxy equivalents of component B) per methylol equivalent of component A). Examples given of component B) include hydroxyethyl acrylate, hydroxypropyl acrylate, hydroxyhexyl acrylate, glyceryl diacrylate, and pentaerythrityl triacrylate; particular preference is given to butanediol monoacrylate. A disadvantage of butanediol monoacrylate as a component is its sharp inherent odor and comparatively high toxicity.

It was an object of the present invention, accordingly, to provide radiation-curable binders for coating compositions that have only a weak inherent odor and a low toxicity and nevertheless meet the usual quality criteria. The radiation-curable binders ought further, in particular, to have a viscosity of not greater than 3500 mPas, a high reactivity of at least 10 m/s, and effective resistance to water and chemicals.

Found accordingly has been a radiation-curable binder which is obtainable by reacting A) amine-formaldehyde condensates with a molar ratio of formaldehyde to amino groups of 1:6 to 2:1, preferably 1:4 to 2:1, in particular 1:1 to 2:1, with B) a mixture of butanediol monoacrylate and 2-hydroxyethyl methacrylate in a ratio of 0.1:100 to 100:0.1, using 0.1 to 1.5 hydroxy equivalents of component B) per methylol equivalent of component A).

Components A) reacted are condensation products of formaldehyde and amino resin formers, suitable amino resin formers including amino-containing compounds such as, for example, urea, melamine, benzoguanamine, acetoguanamine, acetylenediurea, ethyleneurea or propyleneurea. The condensates can be prepared by methods known to the skilled worker in weakly alkaline media, and products with low or high degrees of condensation may be formed in dependence on the reaction conditions. Hexamethylol melamine is preferably used.

According to one preferred embodiment the condensates A) may be present in a form in which they are partly or fully etherified with C₁ to C₆ monoalcohols. The etherification can be carried out according to known methods in an acid medium. Alcohols used are preferably methanol, but also isobutanol, butanol or mixtures of methanol with isobutanol or butanol. As an etherified component A) it is preferred to use hexamethoxymethylmelamine.

Component B) is advantageously a mixture of butanediol monoacrylate and 2-hydroxyethyl methacrylate in a ratio of 1:50 to 50:1, preferably 1:7 to 7:1, more preferably 1:4 to 5:1, and in particular 1:1 to 4:1.

The amount of B) is such that for each methylol equivalent of component A) there are 0.1 to 1.5 hydroxyl equivalents of component B), preferably 0.2 to 1, in particular 0.4 to 0.9.

In addition it is possible as well to add 0.02% to 0.4% by weight, based on the amount of component B), of a polymerization inhibitor C) which allows the self-polymerization of component B) to be prevented. Examples of suitable inhibitors include hydroquinone, hydroquinone monoalkyl ethers, 2,5-di-tert-butyl-4-methylphenol or phenothiazine.

The reaction of A) with B) takes place advantageously in the presence of catalytic amounts of organic or inorganic acids. The acids have advantageously a pH<3.0. Examples of suitable acids include hydrochloric acid, sulfuric acid, oxalic acid, maleic acid, phthalic acid, and para-toluenesulfonic acid. It is usual to use 1 meq to 30 meq of acid per methylol equivalent of component A).

The reaction can be carried out advantageously at temperatures of 50 to 150° C., preferably 60 to 120° C.

By operating under reduced pressure of 0.01 to 0.25 bar, preferably 0.05 to 0.15 bar, volatile constituents of the reaction mixture can be distilled off during the reaction.

The reaction can be ended by neutralizing the acid with bases such as aqueous sodium hydroxide solution or alkylamines such as, for example, triethylamine, tributylamine or alkanolamines such as dibutylethanolamine, diethanolamine or triethanolamine, the end point being chosen such that neutralization takes place when at least 90% by weight of the methanol formed theoretically has been removed by distillation.

The end of the reaction may possibly be followed by a further distillation at around 50 to 100 mbar in order as far as possible to remove any remaining amounts of volatile components.

The binders of the invention are obtained in the form of clear resins which are colorless to pale yellow in color and are viscous, with a viscosity of approximately 1500 to 5000 mPas (23° C.) and which comprise generally less than 5% by weight of free component B. The binders of the invention have a hardness of 90 to 110 swings of the pendulum arm (see Example). The binders of the invention also have only a weak odor. The viscosity, reactivity, and water resistance of the binders of the invention are in accordance with the standard requirements (see Table 3).

The resins of the invention are outstandingly suitable for use as binders for radiation-curable coating compositions, the resins being used in amounts of 10% to 100% by weight, based on total resin mass. Low-viscosity resins having a viscosity of 1000 to 3500 mPas are useful coating compositions per se. Higher-viscosity resins with a viscosity >3500 mPas can in general be diluted only with liquid copolymerizable organic compounds (“reactive diluents”), in which case it is usual to use 0 to 60% by weight of reactive diluent, based on the coating composition. Examples of suitable reactive diluents include butanediol diacrylate, hexanediol diacrylate, trimethylol diacrylate, trimethylolpropane triacrylate or tripropylene glycol diacrylate.

Besides the resins of the invention the coating compositions may additionally comprise 0 to 90% by weight of further photopolymerizable binders, such as polyester acrylates, polyether acrylates, polyurethane acrylates or acrylate-modified epoxy resins.

The coating compositions may further comprise up to 30% by weight of solvents such as are conventional for coatings applications, examples being aromatics, esters, ketones, alcohols or mixtures of such solvents.

However, the solvents must be removed to a very substantial extent prior to radiation curing. Furthermore, conventional film-forming binders, such as polyester resins, alkyd resins, polyacrylate resins, and crosslinkers, such as amino resins, isocyanates or epoxy resins, can also be added in amounts up to 30% by weight.

The coating compositions may further comprise 0 to 80% by weight of pigments such as are suitable for coatings applications.

A further possibility in addition is to use conventional auxiliaries such as thixotropic agents, flow control agents, matting agents, devolatilizers or lubricants in amounts up to 10% by weight.

Curing can be effected either with electron beams with an energy of 100 to 400 kV and a dose of 0.5 to 10 Mrad, or by UV light with a wavelength of 220 to 450 nm and a dose 20 to 1000 mJ/cm³. In the case of curing with UV light the coating compositions are advantageously admixed with photoinitiators such as benzil dimethyl ketal, benzophenone, or acylphosphine oxides, together if appropriate with coinitiators such as dimethylethanolamine, for example, in amounts of 0.5% to 10% by weight.

In addition to the radiation cure the coating may be cured by drying or baking at 30 to 200° C. or by acid catalysis, in which case acidic catalysts that can be added include compounds such as, for example, p-toluenesulfonic acid, maleic acid or phosphoric acid in amounts of 0.2% to 10% by weight.

Such additional curing is particularly advisable even in the case of highly pigmented coating compositions, but also when coating shaped articles with demanding structures, such as chairs or other everyday articles for which it is not guaranteed that the radiation will reach all of the surface to be cured.

The coating compositions of the invention are suitable for coating wood, metal, paper or plastic.

The coatings exhibit good resistance to mechanical stresses.

Particular advantages associated with the binders of the invention are their weak inherent odor and comparatively low toxicity.

### EXAMPLES

### Example 1

A mixture of 390 g (1 mol) of hexamethoxymethylmelamine, 158 g (1.13 mol) of a mixture of butanediol monoacrylate (122 g, 0.85 mol) and 2-hydroxyethyl methacrylate (36 g, 0.28 mol), 0.2 g (0.9 mol) of 2,5-di-tert-butyl-4-methylphenol and 2 g (11 mmol) of p-toluenesulfonic acid was heated to 90° C. Subsequently, over a time period of 30 minutes at a temperature of 80° C. and under a pressure of 0.11 bar to 0.14 bar, approximately 45 g of volatiles were distilled off into a cold trap. The reaction mixture was then neutralized with tributylamine, after which it was subjected to a further distillation at 110° C. and 0.07 to 0.1 bar, in the course of which a further 5 g of volatiles were distilled off. Filtration of the distillation residue gave 510 g of a resin having a viscosity of approximately 3200 mPas (23° C.).

### Comparative Example

### In accordance with EP-B 464 466

A mixture of 390 g (1 mol) of hexamethoxymethylmelamine, 163 g (1.13 mol) butanediol monoacrylate, 0.2 g (0.9 mol) of 2,5-di-tert-butyl-4-methylphenol and 2 g (11 mmol) of p-toluenesulfonic acid was heated to 90° C. Subsequently, over a time period of 30 minutes at a temperature of 80° C. and under a pressure of 0.11 bar to 0.14 bar, approximately 45 g of volatiles were distilled off into a cold trap. The reaction mixture was then neutralized with tributylamine, after which it was subjected to a further distillation at 110° C. and 0.07 to 0.1 bar, in the course of which a further 5 g of volatiles were distilled off. Filtration of the distillation residue gave 510 g of a resin having a viscosity of approximately 5 Pas (23° C.).

### Processing Examples

4 g of benzil dimethyl ketal was added to 100 g of the resin obtained in Example 1 and to 100 g of the resin obtained in the comparative example, and the mixtures were diluted with 12 g of butyl acetate so that their viscosity was 2900 Pas (23° C.). The coating material thus obtained was knife coated in a wet film thickness of 25 μm onto a zinc-phosphated steel panel and after a two-minute flash-off the panels were passed for curing beneath a high-pressure mercury tube with an output of 80 watts/cm, at a belt speed 5 m/min. The glossy film, as hard as nails even after just light exposure, was subsequently baked at 170° C. for 20 minutes.

The performance data are listed in Table 3.

### Performance Tests:

### Viscosity:

The viscosity was determined in accordance with DIN EN ISO 3219.

### Pendulum Damping:

The pendulum damping was determined in a procedure based on DIN 53157, in which the films, UV-cured on a glass plate, were, immediately after UV curing, stored under standard conditions for 24 hours and then subjected to pendulum testing in accordance with DIN 53157.

### Reactivity:

A determination was made of the maximum speed with which a liquid coating film applied immediately beforehand was cured by UV radiation to give a scratch-resistant, tack-free surface.

### Water Resistance:

The water resistance was determined in accordance with DIN 68861 by subjecting the coating film to a cotton pad soaked in water and covering it with a glass dish. After 24 hours at room temperature the cotton pad was removed, the area was dried off, and the result was adjudged in accordance with the scale in the table below.

TABLE 1

| Rat- | | | | | beneath |
|---|---|---|---|---|---|
| ing | Appearance | Blisters | Thumb test | Knife test | film |
| 0 | no change | | | | |
| 1 | minimal | | | | |
| | change | | | | |
| 2 | | very small | scratchproof | loss of | dry |
| | | blisters | | adhesion, | |
| | | | | straight | |
| | | | | cut | |
| 2.5 | | very small | scratchproof | loss of | dry |
| | | blisters | | adhesion, | |
| | | | | coating | |
| | | | | flakes off | |
| 3 | | small | brittle; can be | | dry |
| | | blisters | scratched with | | |
| | | | thumbnail | | |
| 4 | | blisters | can be moved | | wet |
| | | | away from the | | |
| | | | glass with | | |
| | | | thumbnail | | |
| 5 | white | swollen | soft | | wet |
| | | blisters | | | |

### Odor of UV-Curable Binders:

100 g of binder were weighed out into a 200 ml brown glass bottle. The bottle was sealed and left to stand for 24 hours. The odor was evaluated by 6 experimenters on a scale from 0 to 5 immediately following opening of the bottle; the results are set out in Table 2 below. For the blank value a bottle of distilled water was used.

TABLE 2

| | Example 1, inventive (binder: | Comparative Example |
|---|---|---|
| | butanediol monoacrylate:2- | (binder:butanediol |
| | hydroxyethyl methacrylate | monoacrylate in a ratio |
| | in a ratio of 1:3:1 ratio) | of 1:4) |
| Experimenter 1 | 1 | 3 |
| Experimenter 2 | 1 | 3 |
| Experimenter 3 | 3 | 5 |
| Experimenter 4 | 1 | 4 |
| Experimenter 5 | 1 | 2 |
| Experimenter 6 | 2 | 2 |

TABLE 3
Performance data

| | Example 1 | Comparative |
|---|---|---|
| Example | inventive | Example |
| Viscosity [mPas] | 2900 | 2400 |
| Pendulum damping | 98 | 120 |
| [swings of pendulum arm] | | |
| Reactivity [m/s] | 15 | 15 |
| Water resistance | 1 | 1 |
| Average odor evaluation | 1.5 | 3.2 |

1. A radiation-curable binder obtainable obtained by reacting
A) amine-formaldehyde condensates with a molar ratio of formaldehyde to amino groups of 1:6 to 2:1 with
B) a mixture of butanediol monoacrylate and 2-hydroxyethyl methacrylate in a ratio of 0.1:100 to 100:0.1,
wherein 0.1 to 1.5 hydroxy equivalents of component B) are reacted with one methylol equivalent of component A).

2. The radiation-curable binder according to claim 1, wherein the mixture of butanediol monoacrylate and 2-hydroxyethyl methacrylate is in a ratio of 1:7 to 7:1.

3. The radiation-curable binder according to claim 1, obtained by reacting component A) and component B) with a polymerization inhibitor C) in amounts of 0.02% to 0.4% by weight, based on B).

4. The radiation-curable binder according to claim 1, wherein some or all of the methylol groups of component A) are etherified with C₁ to C₆ monoalcohols.

5. The radiation-curable binder according to claim 1, wherein component A) is hexamethoxymethylmelamine.

6. A process for preparing the radiation-curable binder according to claim 1, comprising reacting
A) amine-formaldehyde condensates with a molar ratio of formaldehyde to amino groups of 1:6 to 2:1 with
B) a mixture of butanediol monoacrylate and 2-hydroxyethyl methacrylate in a ratio of 0.1:100 to 100:0.1
in the presence of acid as a catalyst and with distillative removal of volatile reaction products under reduced pressure, wherein 0.1 to 1.5 hydroxy equivalents of component B) are reacted with one methylol equivalent of component A).

7. A curable coating composition comprising 10% to 100% by weight of the radiation-curable binder according to claim 1.

8. A coated article comprising the curable coating composition according to claim 7.
